(19) United States
(12) Patent Application Publication
(10) Pub. No.: US 2011/0066896 A1
(43) Pub. Date: Mar. 17, 2011

(54) ATTACK PACKET DETECTING APPARATUS, ATTACK PACKET DETECTING METHOD, VIDEO RECEIVING APPARATUS, CONTENT RECORDING APPARATUS, AND IP COMMUNICATION APPARATUS

(76) Inventors: Akihiro Ebina, Kyoto (JP); Atsuhiro Tsuji, Osaka (JP)

(21) Appl. No.: 12/992,700

(22) PCT Filed: May 14, 2009
(86) PCT No.: PCT/JP2009/002111

§ 371 Date: Nov. 15, 2010

(30) Foreign Application Priority Data
May 16, 2008 (JP) 2008130061

(51) Int. Cl. G06F 11/30

(52) U.S. Cl. 714/43; 714/E11.179

(57) ABSTRACT

A network interface (101) includes: a packet receiving unit (103); a packet buffer (105); and a transfer unit (106) which transfers packets accumulated in the packet buffer to a main memory (102), and further including: an attack detecting unit (107) which detects an attack in which a large number of packets is transmitted, based on an accumulated amount of packets in the packet buffer (105); a table storing unit (110) for storing an attack packet table (109) in which attack packet identification information is registered; an update unit (108) which updates the attack packet table (109), using information obtained from the packets accumulated in the packet buffer; and a discarding unit (104a) which discards the packets received by the packet receiving unit (103) when the packets correspond to the updated attack packet information, before the packets are transferred to the main memory.

### TECHNICAL FIELD

The present invention relates to attack packet detecting apparatuses and attack packet detecting methods for detecting high-load attacks, such as DoS (Denial of Service) attacks, against communication systems.

### BACKGROUND ART

Conventionally existing DoS attacks disable services and systems by transmitting large amounts of data in short time to network devices having network functions and thereby placing high loads on the network devices.

A well-known attack method in the DoS attack is transmitting a numerous number of ICMP Echo Request packets in short time, using a protocol called ICMP (Internet Control Message Protocol). Conventionally, knowledge of network has been required to perform such DoS attacks.

However, recent years have seen a widespread use of easily available tools for DoS attacks. This makes environments where even a user having little knowledge of network can easily perform such attacks.

For this reason, some methods of preventing such DoS attacks have been disclosed. One example (a first conventional example) is a method involving setting a buffer for temporarily storing TCP packets received and to be processed, in a device that receives and processes the TCP packets, and when the buffer is full, discarding all the TCP packets in the buffer (See PTL 1).

This method prevents an overflow of a memory for reconstruction used to rearrange TCP packets that may arrive in arrival order different from data arrangement order, and thereby protecting the processing system of the device.

Another example (a second conventional example) Is a method involving pre-registering information identifying malicious packets such as attack packets used for DoS attacks, in devices that receive and process packets, and processing packets that do not correspond to the identified information preferentially over the other packets stored in the main memory (See PTL 2).

This method enables the devices to preferentially process packets that should be processed, which reduces decrease in processing efficiency due to DoS attacks.

### CITATION LIST

### [Patent Literature]

### [PTL 1]

US Patent Application Publication No. 2007/0180533

### [PTL 2]

US Patent Application Publication No. 2005/0213570

### SUMMARY OF INVENTION

### Technical Problem

In recent years, as apparatuses having network functions, home appliances such as digital television sets having a low processing capability are increasing, in addition to apparatuses such as routers and PCs (Personal computers) having a high processing capability.

A DoS attack on such a home appliance having a low processing capability may cause a serious problem. In an exemplary case of a digital television set, the digital television set suffers a serious problem that it cannot provide its functions as a television set, for example, functions of providing clear images, good operability, and the like.

First, the aforementioned first conventional method is considered. According to this method, when a large number of packets is transmitted by a DoS attack, packets accumulated in a buffer are discarded without being subjected to any substantial processing such as reconstruction of the packets.

However, not all the packets accumulated in the buffer are malicious packets used in the DoS attack. Thus, even packets that should be processed by the digital television set or the like may be discarded.

Second, the aforementioned second conventional method is considered. According to this method, when a large number of packets is transmitted by a DoS attack, the packets corresponding to pre-registered information about malicious packets are processed as having a low processing priority.

However, when a large number of unregistered packets is transmitted for attack purpose, this method is not sufficient to defend the attack.

If a huge amount of identification information is pre-registered to identify numerous kinds of packets, it is possible to increase the possibility of a defense against such an attack.

However, it is unrealistic especially for home appliances having a low processing capability because of increase in the processing loads that are placed to check each of the packets stored in the main memory with reference to the huge amount of registered information.

Furthermore, it is difficult to predict packets for such attacks to be used in the future. For this reason, even if a huge amount of information is pre-registered, it is difficult to accurately identify malicious packets with reference to the registered information, and there is a possibility that even packets that should be processed are misrecognized as having a low processing priority.

The present invention has been conceived in view of the aforementioned conventional problems, and has an object to provide attack packet detecting apparatuses and attack packet detecting methods for efficiently defending attacks by transmission of large amounts of packets.

### Solution to Problem

In order to solve the aforementioned problem, an attack packet detecting apparatus according to a first aspect of the present invention includes: a receiving unit that receives packets, a packet buffer for accumulating the packets received by the receiving unit, and a transfer unit that transfers the packets accumulated in the packet buffer to a main memory, and the attack packet detecting apparatus further includes: an attack detecting unit configured to detect an attack in which a large number of packets is transmitted, based on an amount of packets accumulated in the packet buffer; a storing unit configured to store attack packet information in which information for identifying attack packets is registered, the attack packets being the large number of packets used in the attack; an update unit configured to update the attack packet information using information obtained from packets accumulated in the packet buffer, when the attack is detected by the attack detecting unit; and a discarding unit configured to discard the packets received by the receiving unit before the packets are transferred to the main memory, when the packets correspond to the information shown by the attack packet information updated by the update unit.

In this way, the attack packet detecting apparatus according to the first aspect of the present invention is capable of updating attack packet information for identifying attack packets, based on information obtained from actually received packets.

This makes it possible to keep the attack packet information having content that reflects an actual situation and is highly useful. More specifically, upon receiving a DoS attack, the attack packet detecting apparatus is capable of efficiently and accurately determining whether to discard the received packets or to transfer the received packets to the main memory.

For example, even when a large number of unknown packets is transmitted for an attack purpose, the attack packet detecting apparatus detects the attack based on the accumulated amount of packets in the packet buffer, and upon the detection, discard the attack packets used for the attack instead of transferring the attack packets to the main memory. In addition, packets that are not attack packets and thus should be processed are transferred to the main memory instead of being discarded.

In other words, this reduces possible load due to these attack packets in the system which processes packets transferred to the main memory, and thereby protecting the system against the attack (the processes Include rearranging the packets, and decoding or coding of data obtained by the rearrangement).

In this way, the attack packet detecting apparatus according to the first aspect is capable of automatically updating the attack packet information according to an actual situation, and discarding malicious packets based on the updated attack packet information. In short, the attack packet detecting apparatus is capable of efficiently defending an attack in which a large number of packets is transmitted.

In addition, the update unit may be configured to obtain attribute information from each of the packets accumulated in the packet buffer, accumulate the number of packets or a total size of packets having the same attribute information, and when a result of the accumulation is equal to or greater than a predetermined threshold value, update the attack packet information by adding the attribute information to the attack packet information, and the discarding unit may be configured to discard the packets when the attribute information of the packets received by the receiving unit is included in the attack packet information updated by the update unit.

In this way, the attack packet detecting apparatus according to the first aspect is capable of determining packets having the header information as attack packets and discarding the attack packets when an accumulation result related to the packets having the same attribute information such as the number of the packets or sizes of the packets exceeds a predetermined threshold value.[0027]

In addition, the update unit may be configured to: hold statistical information for recording (i) header information that is attribute information of the packets accumulated in the packet buffer, and (ii) an accumulated number of the packets or an accumulated size of the packets, in units of packets having the same header information; read the header information of each of the packets accumulated in the packet buffer, when the attack is detected by the attack detecting unit, and either (a) add an entry of the header information to the statistical information when the read-out header information is not included in the statistical information, or (b) either add 1 to the accumulated number of the packets or adds the size of the packet to the accumulated size of the packets when the read-out header information is included in the statistical information, the accumulated number of the packets or the accumulated size of the packets corresponding to the header information; and update the attack packet information indicated by the statistical information by adding, to the attack packet information, the header information corresponding to either the accumulated number of the packets or the accumulated size of the packets which is equal to or greater than the predetermined threshold value.

In this way, in an exemplary case where a large number of packets having mutually different attribute information is transmitted, the accumulated amounts of the packets are precisely recorded for each attribute information.

In addition, the update unit may be configured to obtain attribute information from the packets accumulated in the packet buffer, calculate an amount of increase in either an accumulated number of packets or an accumulated amount of packets having the same attribute information per unit time, and when a result of the calculation is equal to or greater than a predetermined threshold value, update the attack packet information by adding the attribute information to the attack packet information, and the discarding unit may be configured to discard the packets when the attribute information obtained from the packets received by the receiving unit is included in the attack packet information updated by the update unit.

Alternatively, in an exemplary case where the same attribute information such as the accumulation speed of the packets having the same header Information is equal to or greater than the predetermined threshold value, the attack packet detecting apparatus may determine the packets having the header information as attack packets. In this way, in an exemplary case where a large number of packets are transmitted at a moment, damage by the attack is reduced.

In addition, in the attack packet information, an attack pattern that is the information for identifying the attack packets may be registered in advance, the update unit may be configured to update the attack packet information by recording, in the attack packet information, information indicating that the attack pattern is valid when the information obtained from each of the packets accumulated in the packet buffer corresponds to the attack pattern, and the discarding unit may be configured to discard the packet having the valid attack pattern shown by the attack packet information.

In this way, the attack packet detecting apparatus efficiently determines whether or not the received packets are attack packets, and efficiently discards the attack packets.

The attack packet detecting apparatus according to the first aspect may further include a comparing unit configured to compare each of the packets received by the receiving unit and the attack packet information updated by the update unit, and when the packet do not correspond to the information shown by the attack packet information, transmit the packet to the packet buffer, wherein the discarding unit may be configured to discard the packets before the packets are transferred to the packet buffer, when a result of the comparison by the comparing unit shows that the packets correspond to the information shown by the attack packet information, and the packet buffer may be configured to accumulate the packets transferred by the comparing unit.

In this way, the packets determined as the attack packets are discarded instead of being accumulated in the packet buffer. In other words, this prevents increase in the accumulated amount of unnecessary packets in the packet buffer. This secures* in the packet buffer space available for packets to be transferred to the main memory, and thereby appropriately processing these packets transferred from the packet buffer to the main memory.

In addition, the attack detecting unit may be configured to detect the attack by detecting that an accumulated amount of packets accumulated in the packet buffer-or detecting that an amount of increase in the accumulated amount per unit time exceeds a predetermined threshold value.

In this way, the attack packet detecting apparatus is capable of accurately detecting the attack, based on either the accumulated amount of packets to be transmitted or the accumulation speed of the packets.

In addition, the transfer unit may be configured to receive an update of a transfer speed that is the number of packets, which are accumulated in the packet buffer, transferred per unit time to the main memory, and transfer the packets accumulated in the packet buffer at the updated transfer speed.

In this way, the attack packet detecting apparatus is capable of changing a possibility that either the accumulated amount of packets or the amount of increase in the accumulated amount per unit time exceeds the predetermined threshold value. Stated differently, the attack packet detecting apparatus is capable of changing a standard based on which the attack detecting unit determines packets as attack packets, by changing the transfer speed.

In addition, the attack detecting unit may be configured to detect the attack by detecting a packet buffer overflow caused when the accumulated amount of packets accumulated in the packet buffer exceeds the predetermined threshold value.

In this way, the attack packet detecting apparatus is capable of detecting an attack triggered by, for example, reception of an overflow signal from the packet buffer.

A video receiving apparatus according to a second aspect of the present invention receives video data, and displays, on a display device, a video represented by the received video data, and the video receiving apparatus includes: the attack packet detecting apparatus according to the first aspect of the present invention; and a display control unit configured to read packets transferred by the attack packet detecting apparatus to the main memory, and display video included in the read packets on the display device.

A content recording apparatus according to a third aspect of the present invention receives content data including at least one of video data and audio data, and records the received content data, and the content recording apparatus includes: the attack packet detecting apparatus according to the first aspect of the present invention; and a recording unit configured to read, from the main memory, content data including packets transferred by the attack packet detecting apparatus to the main memory, and record the content data on a recording medium.

An IP (Internet Protocol) communication apparatus according to a fourth aspect of the present invention performs IP communication, and includes: the attack packet detecting apparatus according to the first aspect of the present invention; a packet processing unit configured to read, from the main memory, packets transferred by the attack packet detecting apparatus to the main memory, and process the packets to generate a signal including at least one of a video signal and an audio signal; and an output unit configured to output the signal generated by the packet processing unit to an external device.

In this way, the present invention can be implemented as a network configured with a video receiving apparatus including the attack packet detecting apparatus according to the present information.

Furthermore, the present invention can be implemented as an attack packet detecting method having the steps corresponding to the operations performed by the unique structural units of the attack packet detecting apparatus according to the first aspect of the present invention, as a program for causing a computer to execute these steps, and as a recording medium on which the program is recorded. In addition, the program can be distributed via transmission media such as the Internet, and recording media such as DVDs.

### Advantageous Effects of Invention

The present invention makes it possible, upon detection of an attack in which a large number of packets is transmitted, to update attack packet information for identifying attack packets, using information obtained from the received packets. For this reason, it is possible to efficiently and accurately classify packets into packets that should be discarded and packets that should be transferred to the main memory.

In this way, the present invention provides attack packet detecting apparatuses and attack packet detecting methods and the like for efficiently defending attacks by transmission of large amounts of packets.

### CROSS-REFERENCE TO RELATED APPLICATION

This application claims the benefit of Japanese Patent Application No. 2008-130061, filed on May 16, 2008. All the disclosures of the above application including the Description, drawings, and Claims are incorporated herein by reference.

### BRIEF DESCRIPTION OF DRAWINGS

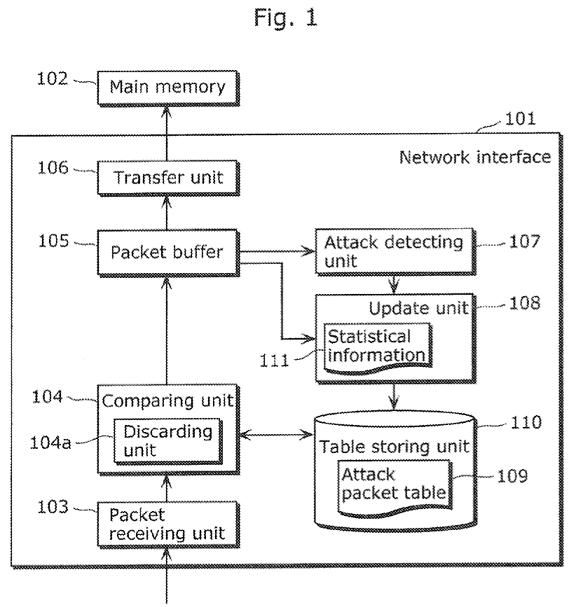

### [FIG. 1]

FIG. 1 is a block diagram showing a structure of a network interface in Embodiment 1.

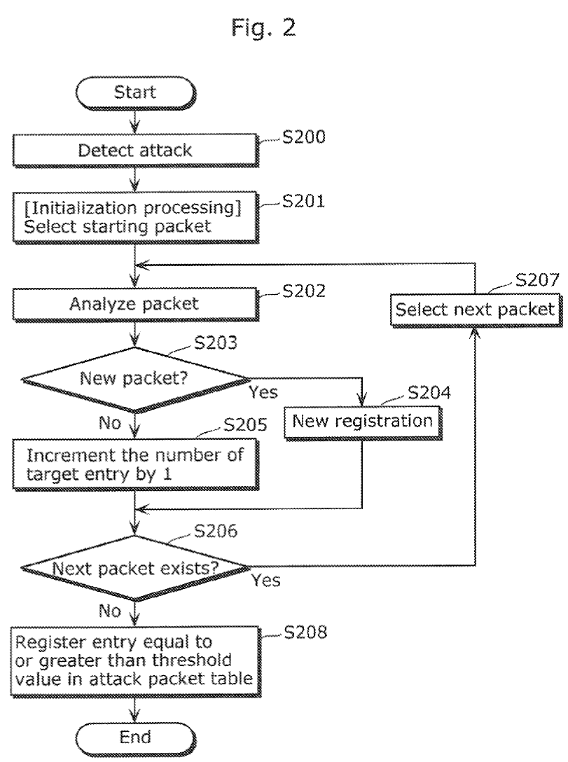

### [FIG. 2]

FIG. 2 is a flowchart showing an exemplary flow of processing performed by a network interface in Embodiment 1 when updating an attack packet table.

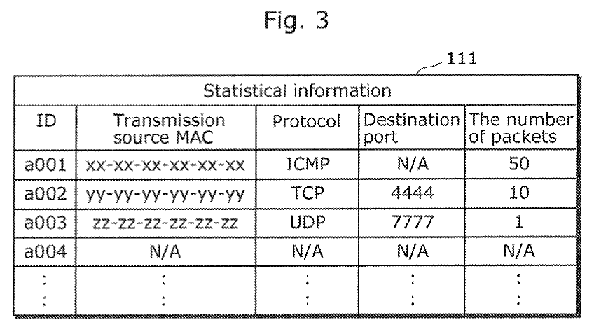

### [FIG. 3]

FIG. 3 is a diagram showing an exemplary data structure of statistical information in Embodiment 1.

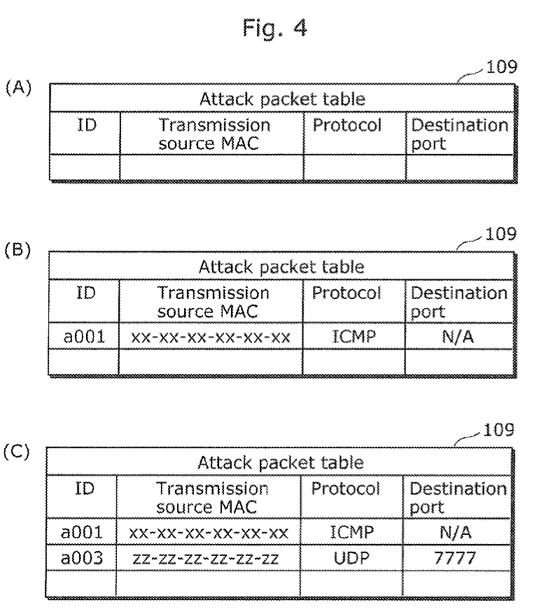

### [FIG. 4]

(A) to (C) in FIG. 4 are first to third examples each showing a data structure of an attack packet table in Embodiment 1.

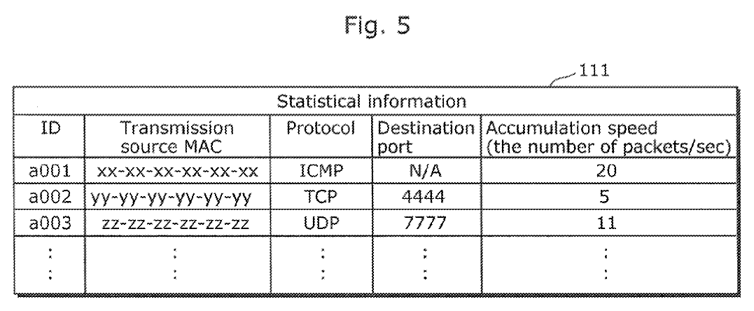

### [FIG. 5]

FIG. 5 is a diagram showing another exemplary data structure of statistical information in Embodiment 1.

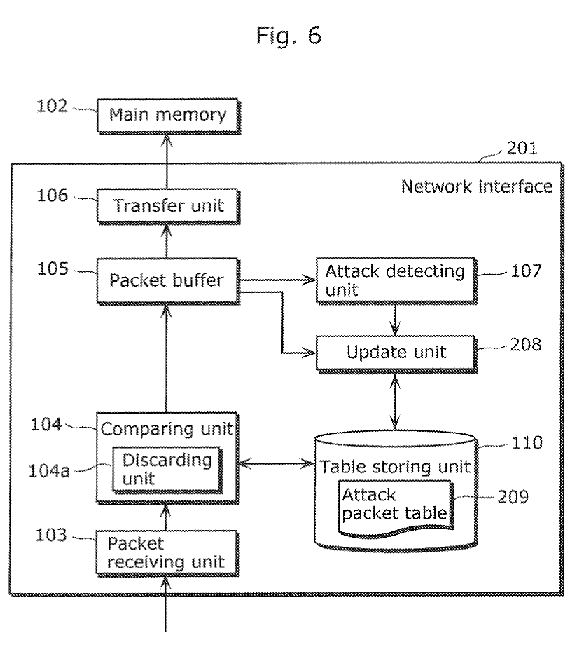

### [FIG. 6]

FIG. 6 is a block diagram showing a structure of a network interface in Embodiment 2.

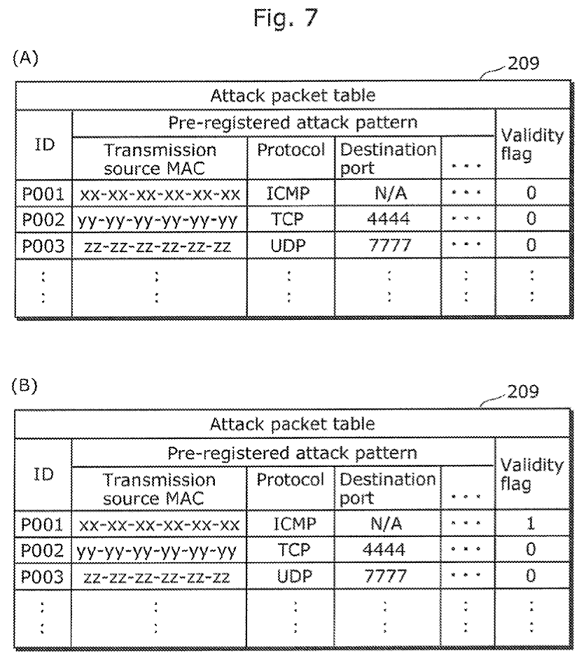

### [FIG. 7]

(A) and (B) in FIG. 7 are first and second examples each showing a data structure of an attack packet table in Embodiment 2.

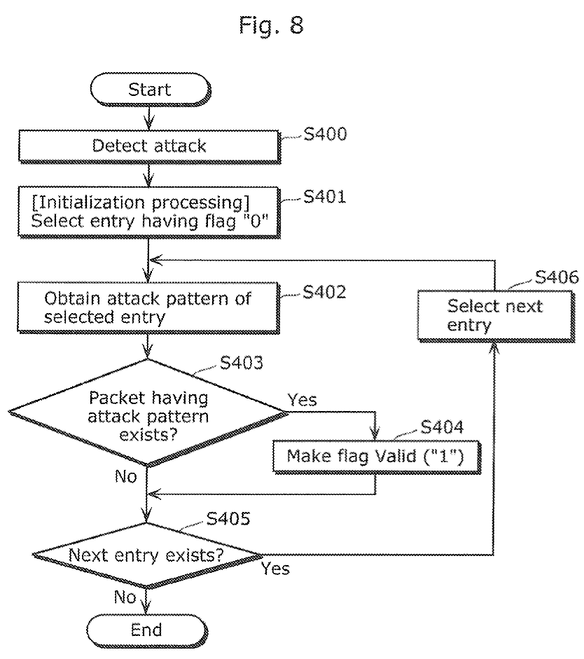

### [FIG. 8]

FIG. 8 is a flowchart showing an exemplary flow of processing performed by a network interface in Embodiment 2 to update an attack packet table.

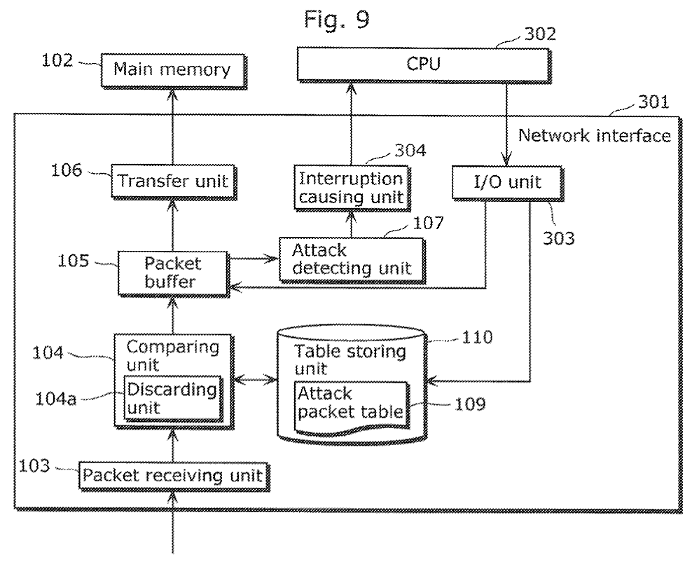

### [FIG. 9]

FIG. 9 is a block diagram showing a structure of a network interface in Embodiment 3.

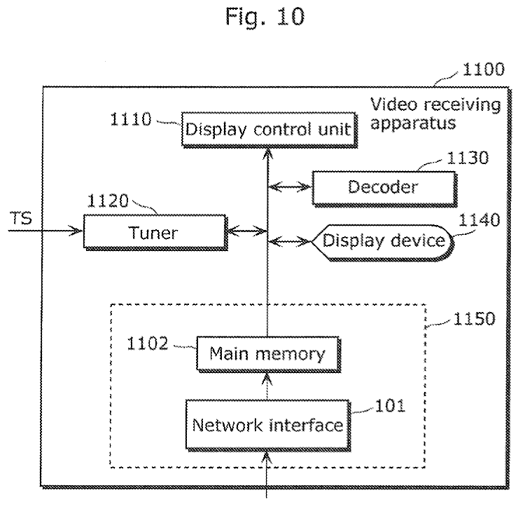

### [FIG. 10]

FIG. 10 is a block diagram showing a main structure of a video receiving apparatus including the network Interface in Embodiment 1.

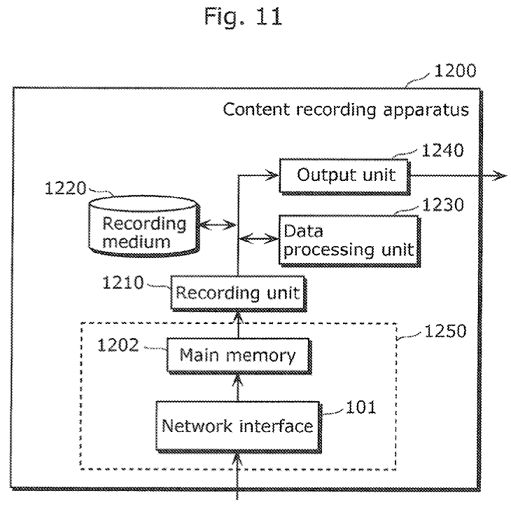

### [FIG. 11]

FIG. 11 is a block diagram showing a main structure of a content recording apparatus including the network interface in Embodiment 1.

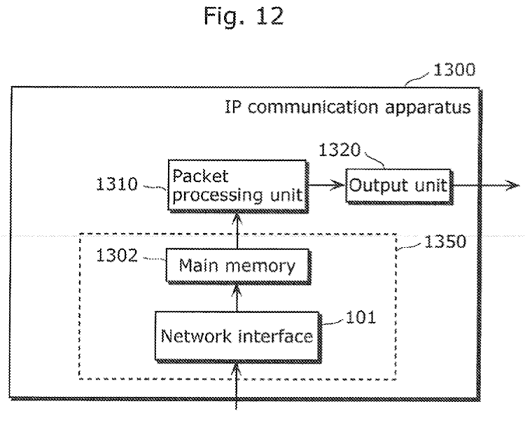

### [FIG. 12]

FIG. 12 is a block diagram showing a main structure of an IP communication apparatus including the network interface in Embodiment 1.

### DESCRIPTION OF EMBODIMENTS

Embodiments according to the present invention are described below with reference to the drawings.

### Embodiment 1

Embodiment 1 is described with reference to FIG. 1 to FIG. 4.

FIG. 1 is a block diagram showing a structure of a network interface 101 in Embodiment 1.

The network interface 101 is an example of an attack packet detecting apparatus according to the present invention.

The network interface 101 includes a packet buffer 105 for accumulating packets received, and transfers the packets accumulated in the packet buffer 105 to a main memory 102.

The main memory 102 is a recording media such as a DRAM (Dynamic Random Access Memory) included in a network apparatus with the network interface 101. The network apparatus performs processing such as reading packets from the main memory 102 and rearranging the packets.

The attack packet detecting apparatus according to the present invention may further include the main memory 102. In this case, the network apparatus provided with the attack packet detecting apparatus reads packets from the main memory 102 included in the attack packet detecting apparatus and rearranges the packets.

In this embodiment, the network interface 101 is configured in form of hardware, and has a function to transfer packets received through a network to the main memory 102.

More specifically, the network interface 101 includes: a packet receiving unit 103 that receives packets transmitted through the network; a table storing unit 110 for storing an attack packet table 109 in which identification information about attack packets used for DoS attacks are registered; a comparing unit 104 that compares each of the packets received by the packet receiving unit 103 (hereinafter, the packets are also referred to as “received packets”) and the information registered in the attack packet table 109; a packet buffer 105 for temporarily buffering the received packets; a transfer unit 106 that transfers the packets accumulated in the packet buffer 105 to the main memory 102; an attack detecting unit 107 that detects DoS attacks by transmission of large amounts of packets, based on an accumulated amount of packets in the packet buffer 105; and an update unit 108 that updates the attack packet table 109 using the information obtained from the packets accumulated in the packet buffer 105 when the attack detecting unit 107 detects a DoS attack.

More specifically, the attack detecting unit 107 detects a DoS attack by detecting a fact that either an accumulated amount of packets accumulated in the packet buffer 105 or an amount of increase in the accumulated amount per unit time exceeds a predetermined threshold value.

In this embodiment, the attack detecting unit 107 detects a DoS attack by detecting an overflow of the packet buffer 105 caused when the accumulated amount of packets exceeds the threshold value.

The update unit 108 holds statistical information 111 indicating results of statistics about plural received packets. The update unit 108 updates the attack packet table 109 using the statistical information 111. The statistical information 111 is described later with reference to FIG. 3. The attack packet table 109 is described later with reference to FIG. 4(A), (B), and (C).

The attack packet table 109 is a first example of attack packet information in the attack packet detecting apparatus in this embodiment. The attack packet table 109 is stored in the table storing unit 110 as shown in FIG. 1.

The table storing unit 110 is implemented as a non-volatile recording medium such as an HDD (Hard disk drive) or an EEPROM (Electrically Erasable and Programmable Read Only Memory).

The network interface 101 further includes a discarding unit 104a. The discarding unit 104a discards received packets when comparison by the comparing unit 104 shows that the received packets correspond to information registered in the attack packet table 109.

When comparison by the comparing unit 104 shows that the received packets do not correspond to the information registered in the attack packet table 109, the comparing unit 104 transfers the received packets to the packet buffer 105.

The packet buffer 105 is a memory having a function such as FIFO (First In, First Out).

The comparing unit 104 inputs packets into the packet buffer 105. The transfer unit 106 extracts the packets from the packet buffer 105.

However, when an overflow of the packet buffer 105 occurs because the transfer unit 106 cannot perform the extraction processing timely, an overflow signal is issued by the packet buffer 105.

The attack detecting unit 107 detects the overflow of the packet buffer 105 upon receiving the overflow signal from the packet buffer 105. Thereby, the attack detecting unit 107 detects the DoS attack.

In this way, the network interface 101 in this embodiment includes the comparing unit 104. The comparing unit 104 has a function of detecting attack packets by comparing received packets and attack packet identification information indicated in the attack packet table 109, and a function of selectively transferring the received packets to the packet buffer 105 depending on the content of the attack packet table 109.

The comparing unit 104 includes the discarding unit 104a, and thus also has a function of discarding packets determined to be attack packets.

The network interface 101 in this embodiment includes the attack detecting unit 107 that detects a DoS attack, based on the accumulated amount of packets in the packet buffer 105. In this embodiment, the attack detecting unit 107 detects a DoS attack by detecting an overflow of the packet buffer 105.

The network interface 101 in this embodiment includes the update unit 108 that updates the attack packet table 109 using the information obtained from the packets accumulated in the packet buffer 105 when the attack detecting unit 107 detects the DoS attack.

FIG. 2 is used to describe the flow of processing performed by the network interface 101 configured as described above in this embodiment.

FIG. 2 is a flowchart showing an exemplary flow of processing performed by the network interface 101 in Embodiment 1 when updating the attack packet table 109.

First, the attack detecting unit 107 detects a DoS attack by detecting an overflow of the packet buffer 105 (S200).

The attack detecting unit 107 transmits a predetermined signal to the update unit 108 upon the detection of the DoS attack.

Upon receiving the signal, the update unit 108 selects the starting packet among the packets accumulated in the packet buffer 105 (S201). Furthermore, the update unit 108 analyzes the headers of the selected packets to obtain packet information accumulated in the packet buffer 105 (S202).

By the header analysis (S202), the update unit 108 obtains information required to determine attack packets; examples of such information includes the transmission source MAC (Media Access Control) address, protocol type, and destination port information of an Ether frame header.

The transmission source MAC address and the like are examples of attribute information in the attack packet detecting apparatus in this embodiment.

The update unit 108 determines whether or not the packets should be newly registered in the statistical information 111, based on the analysis result (S203).

More specifically, in the case where the statistical information 111 does not include an entry corresponding to the result of analyzing the headers of the packets, the update unit 108 registers the set of information items including the transmission source address and the like resulting from the analysis into the statistical information 111 as a new entry (S204).

In the case where the statistical information 111 includes an entry corresponding to the result of the header analysis, the update unit 108 adds 1 to the number in the column for the number of the packets. In this way, the number of packets having the same header information is accumulated.

Next, the update unit 108 determines whether or not a next packet is input into the packet buffer 105 (S206).

When the next packet is present (“Yes” in S206), the update unit 108 selects the next packet (S207), and repeats the processing from a packet analysis (S202) to a presence/absence check (S206) for a still next packet.

When the next packet is not present (“No” in S206), the update unit 108 checks whether or not the statistical information 111 includes such an entry having a registered number equal to or greater than the threshold value.

When such an entry having the registered number equal to or greater than the threshold value are present, the update unit 108 determines the packets corresponding to the entry as attack packets, and registers the entry including the transmission source address into the attack packet table 109 (S208).

In the example of processing flow shown in FIG. 2, the update unit 108 performs packet analysis starting with the starting packet in the packet buffer 105. However, such analysis may be performed in a random order as long as it is possible to obtain information such as the types of the packets accumulated in the packet buffer 105.

In the packet analysis (S202), the update unit 108 obtains the transmission source address, the protocol type, and the destination port from each Ether frame header, and registers the obtained information in the statistical information 111 as an entry.

However, the header information obtained in the packet analysis is not limited to these parameters, and it is also good to obtain arbitrary parameters and use these parameters to determine the need to register these parameters into the statistical information 111 (S203). In addition, it is also good to register the obtained parameters into the statistical information 111 as an entry.[0091]

The threshold value used to determine (S208) the entry that should be registered in the attack packet table 109 from among the entries included in the statistical information 111 may be registered in, for example, a non-volatile recording medium such as a table storing unit 110 included in the network interface 101.

A host using the network interface 101 may be configured to set the threshold value.

FIG. 3 is a diagram showing an exemplary data structure of the statistical information 111 in Embodiment 1.

The statistical information 111 is used in the aforementioned various kinds of processing (S203 to S205, and S208).

More specifically, recorded therein is header information of each kinds of packets obtained when analysis of all the packets in the packet buffer 105 is completed.

As shown in FIG. 3, the statistical information 111 is made up of header information obtained by packet analysis (S202), the ID identifying each entry, and an item for recording the number of input packets corresponding to each entry into the packet buffer 105.

For example, when the aforementioned threshold value is “50”, the update unit 108 determines a001 that is the entry satisfying the condition that the number in the column for “the number” is 50 or more, with reference to the statistical information 111.[0098]

The protocol recorded in a001 is ICMP, which indicates reception of a DoS attack by Ping Flood by the ICMP protocol. The transmission source MAC (Media Access Control) address recorded in a001 is “xx-xx-xx-xx-xx-xx”.

Thus, the update unit 108 registers the entry of a001 into the attack packet table 109 so that the packets transmitted by the ICMP protocol are discarded from the transmission source MAC address “xx-xx-xx-xx-xx-xx”.

(A) to (C) in FIG. 4 are first to third examples each showing a data structure of the attack packet table 109 in Embodiment 1.

For example, as shown in FIG. 4(A), it is assumed that the attack packet table 109 does not register any attack packet identification information.

In the case where the attack detecting unit 107 detects a DoS attack in this state, the update unit 108 performs aforementioned packet analysis, and also performs processing such as registering a new entry or incrementing the number of packets in the entry in the statistical information 111.

As a result, for example, each entry is recorded in the statistical information 111 as shown in FIG. 3. When the threshold value for the number is “50”, the update unit 108 reads the entry of a001 from the statistical information 111, and registers the entry into the attack packet table 109 as shown in FIG. 4(B).

For example, it is assumed that processing from an attack detection (S200) to a presence/absence check for an unanalyzed packet (S206) as shown in FIG. 2 is performed subsequently, and “50” is set in the column for the number of packets of, for example, a003 in the statistical information 111.

In this case, as shown in FIG. 4(C), the entry of a003 is read from the statistical information 111 and is registered in the attack packet table 109.

In this way, the update unit 108 in this embodiment determines an entry that should be registered in the attack packet table 109 from among the entries recorded in the statistical information 111 by performing the processing using the statistical information 111 and the threshold value. Furthermore, the content of the determined entry is registered in the attack packet table 109.

In this way, the attack packet table 109 is updated. More specifically, the update unit 108 adds attack packet identification information to the attack packet table 109.

The comparing unit 104 compares the transmission source MAC address and the like of each entry registered in the attack packet table 109 and the header information of each of the packets received by the packet receiving unit 103, with reference to the attack packet table 109 updated by the update unit 108. In this way, the attack packet that should be discarded is determined. The discarding unit 104a discards the determined attack packet.

As described above, upon detecting a DoS attack, the network interface 101 in this embodiment updates the attack packet table 109, using information obtained from the packets accumulated in the packet buffer 105. Furthermore, the network interface 101 determines attack packets from among the received packets by comparing the received packets and the updated attack packet table 109. [0110]

Furthermore, the network interface 101 discards the received packets determined to be attack packets instead of transferring them to the main memory 102.

The network interface 101 temporarily stores the received packets other than the attack packets in the packet buffer 105, and transfers them to the main memory 102. In short, the received packets that should be processed are appropriately processed.

In this way, the network interface 101 in this embodiment automatically updates the attack packet table 109, and thereby efficiently classifying the received packets into the packets that should be discarded and the packets that should be transferred to the main memory 102.

Even when unknown attack packets are received, information identifying these attack packets is added to the attack packet table 109, and the packets corresponding to the information are discarded instead of being transferred to the main memory 102.

Since the attack packets are discarded inside the network interface 101, it is possible to reduce the processing such as an interruption to the CPU (Central Processing Unit) of the network apparatus provided with the network interface 101.

Furthermore, attack packets that are received while the packet buffer 105 is being overflowed are discarded inside the network interface 101. Accordingly, the network apparatus can process the packets transferred to the main memory 102 without performing any substantial processing on the attack packets.

In this way, the network interface 101 in this Embodiment can efficiently prevent an attack without increasing a load on the CPU of the network apparatus that reads the packets from the main memory 102 and processes the packets.

The statistical information 111 is assumed to be held in the update unit 108. However, the statistical information 111 may be recorded in, for example, a non-volatile recording medium such as a table storing unit 110 included in the network interface 101.

In this embodiment, the update unit 108 is assumed to record, for each header information, the number of packets having the same header information in the statistical information 111 (See FIG. 3). Stated differently, the update unit 108 is assumed to accumulate the number of packets having the same header information. However, the update unit 108 may accumulate the size of the packets having the same header information.

In this case, the column for the number of each entry is changed to “size” in the statistical information 111 shown in FIG. 3. The update unit 108 obtains the size of each packet in the packet buffer 105, and adds the size of the packet to the corresponding column for the “size” of the entry. In this way, the accumulated size for each header information is recorded in the column for “size” of the corresponding entry.

Furthermore, the update unit 108 compares a predetermined size that is a threshold value and the accumulated size of each entry recorded in the statistical information 111, and thereby determining an entry having an accumulated size equal to or greater than the threshold value. The update unit 108 further adds the transmission source MAC address and the like of the determined entry to the attack packet table 109. In this way, the attack packet table 109 is updated.

In short, the amount of packets may be determined as either the number of the packets or the size of the packets as long as it is used to quantitatively record the amount of packets having the same header information received by the network interface 101.

Alternatively, the update unit may record an amount of increase in the amount per unit time into the statistical information 111 instead of recording the amount of the packets having the same header information.

FIG. 5 is a diagram showing another exemplary data structure of the statistical information 111 in Embodiment 1.

The statistical information 111 shown in FIG. 5 has recorded therein an accumulation speed that is the accumulated number per unit time for each header information.

For example, the update unit 108 monitors the packet buffer 105, and detects the number of packets having the same header information input to the packet buffer 105 per unit time. Furthermore, the update unit calculates the accumulation speed for each header information, based on the detection result.

For example, the update unit 108 may calculate the accumulation speed for each header information, based on the reception interval of two packets having the same header information.

In the case where the accumulation speed for each header information is recorded in the statistical information 111, the update unit 108 determines an entry having the accumulation speed equal to or greater than the predetermined threshold value, and adds the determined entry to the attack packet table 109. In this way, the attack packet table 109 is updated.

The accumulation speed may be an accumulated size per unit time instead of the accumulated number per unit time.

In either case, it is possible to determine that the reception frequency of packets having the same header information is high when the accumulation speed of the packets is indicated by a large number. Accordingly, it is possible to determine whether or not current packets are attack packets or not depending on whether or not the accumulation speed is greater than the threshold value.

In this embodiment, the attack detecting unit 107 detects a DoS attack by detecting an overflow of the packet buffer 105.

However, the attack detecting unit 107 may detect the DoS attack by detecting that the accumulated amount of packets in the packet buffer 105 exceeds the predetermined threshold value that is smaller than the capacity of the packet buffer 105.

For example, the attack detecting unit 107 may detect a DoS attack by detecting that the accumulated amount in the packet buffer 105 exceeds 80% of the capacity up to which accumulation is possible. This threshold value may be variable, and may be set to the attack detecting unit 107 from outside of the network interface 101.

In this way, for example, it is possible to prevent the packet buffer 105 from overflowing by starting discarding attack packets before a possible overflow of the packet buffer 105.

As a result, it is also possible to prevent a situation that packets to be transferred to the main memory 102 cannot be input to the packet buffer 105.

Reducing the threshold value makes it possible to surely detect a DoS attack when the packet buffer 105 is unlikely to overflow, for example, in the case where the packet buffer 105 has a comparatively large capacity, and in the case where the transfer unit 106 transfers the packets to the main memory 102 in units of a comparatively large number of packets per unit time (hereinafter referred to as “transfer speed”).

In this way, the standard for determination on whether or not a DoS attack is being made is not limited to a particular standard, and may be set appropriately according to, for example, the capacity of the packet buffer 105, and the number of packets that can be determined to be used for DoS attacks.

The transfer speed of the transfer unit 106 may be fixed or variable. For example, the transfer speed may be determined depending on the bandwidth of a bus used for transfer to the main memory 102.

The transfer unit 106 may receive an update of the transfer speed from outside the network interface 101, and transfer the packets at the updated transfer speed.

In this way, it is possible to change the likelihood of an overflow of the packet buffer 105 when it is possible to change the transfer speed of the transfer unit 106. More specifically, the likelihood of an overflow of the packet buffer 105 decreases with increase in the transfer speed of the transfer unit 106.

In contrast, the likelihood of an overflow of the packet buffer 105 increases with decrease in the transfer speed of the transfer unit 106.

In short, using variable transfer speeds for the transfer unit 106 makes it possible to change the standards for determination on whether or not a DoS attack is being made.

The update unit 108 may determine the priority of the entries in the attack packet table 109 according to the accumulated numbers. More specifically, it is also good to register the entries such that an entry having a larger accumulated number is listed in a higher position in the attack packet table 109.

This enables efficient determination on whether or not received packets are attack packets when, for example, the comparing unit 104 is configured to compare the received packets and each of the entries in the attack packet table 109 according to the priority order.

In this embodiment, the update unit 108 registers, in the attack packet table 109, an entry having a registered number equal to or greater than the threshold value in the statistical information 111 when analysis of all the packets in the packet buffer 105 is completed.

However, it is also good to register the entry having the number equal to or greater than the threshold value in the attack packet table 109 before the analysis of all the packets in the packet buffer 105 is completed.

In this way, it is possible to execute a quick defense against the DoS attack by starting discarding attack packets before the completion of analysis of all the packets in the packet buffer 105.

Each of the statistical information 111 and the attack packet table 109 may be initialized at an arbitrary timing as necessary. Stated differently, each of entries registered therein may be deleted at an arbitrary timing.

For example, if the discarding unit 104a discards attack packets a less number of times per unit time, it is highly likely that a DoS attack is finished. Thus, the attack packet table 109 may be initialized. This increases, for example, efficiency in the comparison by the comparing unit 104.

There is a possibility that a DoS attack of a different kind is made when a communication environment for the network interface 101 is changed, for example, when the IP address assigned with the network interface 101 is changed, or when the network cable inserted in the network interface 101 is pulled off from and re-inserted to the network interface 101.

In such a case, each of the statistical information 111 and the attack packet table 109 may be initialized.

For example, preventing header information that becomes unnecessary due to change in the communication environment from being stored in the statistical information 111 and the attack packet table 109 increases the processing efficiencies of the update unit 108 and the comparing unit 104 in this way.

It is assumed here that attack packets corresponding to an entry deleted from each of the statistical information 111 and the attack packet table 109 are transmitted after the deletion. In this case, these attack packets pass through the comparing unit 104 until an attack is detected based on an overflow of the packet buffer 105, or the like. However, information identifying the attack packets is re-registered in the statistical information 111 and the attack packet table 109 after the detection of the attack, and thus no substantial problem arises.

### Embodiment 2

Next, Embodiment 2 is described with reference to FIGS. 6, 7, and 8.

FIG. 6 is a block diagram showing a structure of a network interface 201 in Embodiment 2.

The network interface 201 in Embodiment 2 is another example of an attack packet detecting apparatus according to the present invention. As shown In FIG. 6, the network interface 201 has approximately the same structure as that of the network interface 101 in Embodiment 1 as shown in FIG. 1.

However, the network interface 201 in Embodiment 2 is different from the network interface 101 in Embodiment 1 in that the network interface 201 pre-registers possible attack patterns in an attack packet table 209, validates one of the registered attack patterns that corresponds to a DoS attack detected, and discards received packets corresponding to the attack pattern.

More specifically, a table storing unit 110 has recorded therein an attack packet table 209 in which possible attack patterns are pre-registered.

The network interface 201 in Embodiment 2 does not hold statistical information 111 because it does not need any statistical information 111 unlike the update unit 108 in Embodiment 1.

(A) and (B) in FIG. 7 are first and second examples each showing a data structure of the attack packet table 209 in Embodiment 2.

The attack packet table 209 registers the second example of the attack packet information in the attack packet detecting apparatus, that is, a table in which information indicating at least one pre-set attack pattern is registered.

As shown in FIG. 7(A), the attack packet table 209 includes plural entries. Each entry includes the ID identifying the entry, a “pre-registered attack pattern” that is an item indicating an attack pattern for determining a DoS attack packet, and a “validity flag.” that is an item indicating whether or not the entry is valid.

As in the case of the attack packet table 109 in Embodiment 1, the attack packet table 209 records, as the pre-registered attack pattern, header information including a transmission source MAC address identifying attack packets.

The comparing unit 104 reads information identifying the attack pattern from only an entry having a validity flag “1”, and compares the identification information and the header information of the received packet.

In the attack packet table 209 shown in FIG. 7(A), each of the entries has a validity flag “0”. In this case, the comparing unit 104 does not compare the received packets and the at least one attack pattern registered in the attack packet table 209.

Here, it is assumed that the attack packet table 209 shown in FIG. 7(A) is updated by the update unit 208, for example, such that the entry having an ID of P001 has a validity flag “1”.

In this case, the comparing unit 104 compares the received packets and the information indicating the attack pattern shown in the entry of P001.

If the comparison shows a correspondence between the received packets and the information, the discarding unit 104a discards the received packets.

If the comparison shows a non-correspondence between the received packets and the information, the discarding unit 104a transfers the received packets to the packet buffer 105. The packets transferred to the packet buffer 105 are transferred to the main memory 102.

As in Embodiment 1, the packets that should be discarded are discarded and the packets that should be transferred to the main memory 102 are transferred to the main memory 102 among the plural packets received by the packet receiving unit 103 in this way.

Methods of pre-registering information to the attack packet table 209 are not limited to particular methods. For example, information indicating attack patterns may be pre-registered in the attack packet table 209 by a user.

For example, when the network interface 201 is connected to a network, the network interface 201 may receive the information indicating attack patterns from a server that provides the information via the network, and the update unit 208 may register the received information in the attack packet table 209.

Next, with reference to FIG. 8, a description is given of processing performed by the network interface 201 to update the attack packet table 209.

FIG. 8 is a flowchart showing an exemplary flow of processing performed by the network interface 201 in Embodiment 2 to update the attack packet table 209.

First, the attack detecting unit 107 detects a DoS attack by detecting an overflow of the packet buffer 105 (S400).

The attack detecting unit 107 transmits a predetermined signal to the update unit 208 upon detection of the DoS attack.

The update unit 208 that receives the signal selects one entry having a validity flag “0” from among the entries pre-registered in the attack packet table 209 (S401).

The update unit 208 obtains attack pattern information for identifying DoS attack packets registered in the selected entry (S402); the attack pattern information includes the transmission source MAC address, protocol type, destination port information, and the like of the Ether frame header.

The update unit 208 checks whether or not packets corresponding to the obtained attack pattern information are present in the packet buffer 105 (S403).

When such packets are present (“Yes” in S403), the update unit 208 changes the validity flag of the entry in the attack packet table 209 to “1” indicating validity (S404).

The update unit 208 checks whether or not there is a next entry having a validity flag “0” in the attack packet table 209 (S405). When the next entry is present (“Yes” in S405), the update unit 208 selects the entry (S406). Subsequently, the update unit 208 repeats processing from the obtainment of attack pattern information (S402) to a check of presence/absence of a next entry having a validity flag “0” (S405).

The attack packet table 209 completes the update processing on the attack packet table 209 when there is no next entry having a validity flag “0” (“No” in S405).

In this way, the network interface 201 in Embodiment 2 holds the attack packet table 209 in which attack packet identification information is pre-registered.

When the attack detecting unit 107 detects a DoS attack, the update unit 208 compares each of the packets in the packet buffer 105 and the attack pattern information pre-registered in the attack packet table 209.

If the comparison shows that packets corresponding to the registered attack pattern information are present in the packet buffer 105, the validity flag of the attack pattern is changed to “1”. In short, the attack packet table 209 is updated using information obtained from the packets accumulated in the packet buffer 105.

In this way, as in the network interface 101 in Embodiment 1, the network interface 201 in Embodiment 2 automatically updates the attack packet table 209, and thereby efficiently classifying the received packets into the packets that should be discarded and the packets that should be transferred to the main memory 102.

More specifically, it is only necessary that the comparing unit 104 compares each of the received packets and only the entry having a validity flag “1” among the plural entries registered in the attack packet table 209. In this way, the comparing unit 104 can efficiently and accurately determine whether or not the received packets are attack packets.

Therefore, the network interface 201 in Embodiment 2 is capable of efficiently defending attacks by transmission of large amounts of packets.

In Embodiment 2, the attack pattern information registered in the attack packet table 209 are assumed to be the transmission source MAC address, protocol type, and destination port information of each Ether frame header.

However, the attack pattern information is not limited to such header information, and may be information included in another field within the header portion of each packet. For example, the information indicating the length of each packet may be included in the attack pattern information.

The attack pattern information is not limited to header information, and may be obtained from data portions of various kinds of protocols and registered in the attack packet table 209 as attack pattern information. In short, information other than header information may be used in the comparison by the comparing unit 104.

With the network interface 201 in Embodiment 2 as described above, it is possible to flexibly process packets whose protocols cannot be analyzed by the network interface 201.

### Embodiment 3

Next, Embodiment 3 is described with reference to FIG. 9.

A network interface 301 in Embodiment 3 is intended to perform, in a higher application layer, processing performed by the update unit 108 that uses hardware in the network interface 101 in Embodiment 1.

More specifically, in Embodiment 3, the processing such as update of an attack packet table 109 by the update unit 108 is performed by a CPU 302 of a network apparatus provided with the network interface 301.

In this embodiment, the attack packet detecting apparatus is configured with at least the network Interface 301 and the CPU 302.

FIG. 9 is a block diagram showing a structure of a network interface 301 in Embodiment 3.

The network Interface 301 includes a packet buffer 105 for accumulating packets received, and transfers the packets accumulated in the packet buffer 105 to a main memory 102.

The network interface 301 includes: a packet receiving unit 103; a comparing unit 104; a packet buffer 105; a transfer unit 106; an attack detecting unit 107 that notifies an interruption causing unit 304 of a fact that the packet buffer 105 detects its overflow upon detection; the interruption causing unit 304 that causes the CPU 302 to make an interruption when the interruption causing unit 304 receives the notification from the attack detecting unit 107; an I/O unit 303 that enables the CPU 302 to access the packet buffer 105 and the attack packet table 109 of the network interface 301; and a table storing unit 110 that stores the attack packet table 109.

In short, the interruption causing unit 304 functions as a notifying unit that notifies the CPU 302 of an overflow of the packet buffer 105. In addition, the I/O unit 303 functions as an input and output unit that connects the CPU 302 and the packet buffer 105 so that the CPU 302 can access the content in the packet buffer 105.

In this Embodiment, when the CPU 302 receives an interruption signal from the interruption causing unit 304, the CPU 302 executes an attack determination program stored in the non-volatile recording medium (not shown in FIG. 9) that is, for example, an HDD or an EEPROM.

Data similar to the statistical information 111 in Embodiment 1 is stored in such a non-volatile recording medium.

This structure enables execution of the same processing as the processing from packet analysis (S202 in FIG. 2) to attack packet table update (S208 in FIG. 2) that are performed by the update unit 108 in Embodiment 1.

In short, when a DoS attack is detected by the attack detecting unit 107, the attack packet table 109 is updated by execution of the attack determination program by the CPU 302.

In this way, in this embodiment, the update unit in the attack packet detecting apparatus is configured with the interruption causing unit 304, the CPU 302, and the I/O unit 303. This makes it easy to defend attack packets at a timing of the DoS attack even in the higher application layer.

### Application Examples of Embodiments 1 to 3

As described above, in Embodiments 1 to 3, each of the network interfaces 101, 201, and 301 includes a packet buffer 105 that accumulates received packets, and has a function of discarding attack packets before these packets are transferred to the main memory 102.

In addition, each of the network interfaces 101, 201, and 301 is capable of updating one of the attack packet tables 109 and 209 referred to in discarding attack packets, using information obtained from packets accumulated in the packet buffer 105. In this way, efficient defense against DoS attacks is achieved.

Accordingly, each of the network interfaces 101, 201, and 301 is useful as a structural element that protects home appliances having a low processing capability from DoS attacks.

Taking the network interface 101 in Embodiment 1 as an example, configurations of three types of home appliances each provided with a network interface 101 are described with reference to FIGS. 10 to 12.

FIG. 10 is a block diagram showing a main structure of a video receiving apparatus 1100 including the network interface 101 in Embodiment 1.

For example, the video receiving apparatus 1100 shown in FIG. 10 is a television set that receives and displays broadcast data, and includes a display control unit 1110, a tuner 1120, a decoder 1130, a display device 1140, and an attack packet detecting apparatus 1150.

The attack packet detecting apparatus 1150 includes a network interface 101, and a main memory 102.

In the video receiving apparatus 1100, the decoder 1130 decodes broadcast data (such as an MPEG-2 TS (Transport Stream)) received by the tuner 1120. The video obtained by the decoding is displayed on the display device 1140. This processing sequence is controlled by the display control unit 1110.

The video receiving apparatus 1100 is connected to the network such as the Internet via the network interface 101. The network interface 101 receives data to be divided into plural packets and transmitted in form of the packets; examples of such data include moving picture data, still picture data, an HTML (Hyper Text Markup Language) file, and text data.

At this time, as described using FIG. 2 and the like, the network interface 101 discards attack packets among received packets, based on the attack packet table 109. In addition, non-attack packets are transferred to the main memory 1102.

The display control unit 1110 reads the packets from the main memory 1102, and displays information shown by the read-out packets on the display device 1140.

In this way, for example, Web content received via the Internet is displayed on the display device.

Each of the various kinds of processing functions of the display control unit 1110 is achieved by, for example, execution of a predetermined program by a computer that includes a CPU, a recording device, an interface for input and output of information, and the like.

As described above, the video receiving apparatus 1100 includes the attack packet detecting apparatus 1150. In this way, even when the video receiving apparatus 1100 receives a DoS attack, the attack packets are discarded within the network interface 101, and the packets that make up Web Content and the like are transferred to the main memory 1102 and are appropriately processed by the display control unit 1110.

Even when unknown attack packets are transmitted, the video receiving apparatus 1100 is capable of updating the attack packet table 109, and thereby discarding the attack packets before the attack packets are transferred to the main memory 1102. In short, the video receiving apparatus 1100 is capable of defending Dos attacks efficiently.

FIG. 11 is a block diagram showing a main structure of a content recording apparatus 1200 including the network interface 101 in Embodiment 1.

The content recording apparatus 1200 shown in FIG. 11 receives content data including at least one of video data and audio data, and records the received content data. The content recording apparatus 1200 is implemented as a hard disk recorder, Blu-ray disc recorder, or the like.

The content recording apparatus 1200 includes a recording unit 1210, a recording medium 1220, a data processing unit 1230, an output unit 1240, and an attack packet detecting apparatus 1250.

The attack packet detecting apparatus 1250 includes a network interface 101, and a main memory 1202.

The content recording apparatus 1200 receives content data transmitted in units of packets via the network interface 101. The received content data is recorded in the recording medium 1220 by the recording unit 1210. At this time, the data processing unit 1230 performs processing such as decoding, and compressing and coding on the content data, according to user settings or the like. The processed content data is recorded in the recording medium 1220 by the recording unit 1210.

The content data recorded in the recording medium 1220 is subjected to processing such as decoding by the data processing unit 1230, and is output from the output unit 1240.

Here, more specifically, the recording unit 1210 reads out, from the main memory 1202, the packets transferred from the network interface 101 to the main memory 1202, and then records the packets in the recording medium 1220.

Accordingly, even when the content recording apparatus 1200 receives a DoS attack, the attack packets are discarded within the network interface 101, and the packets that make up the content data are transferred to the main memory 1202, and appropriately processed by the recording unit 1210.

Even when unknown attack packets are transmitted, the content recording apparatus 1200 is capable of updating the attack packet table 109, and thereby discarding the attack packets before the attack packets are transferred to the main memory 1202. In short, the content recording apparatus is capable of defending Dos attacks efficiently.

FIG. 12 is a block diagram showing a main structure of an IP communication apparatus 1300 Including the network interface 101 in Embodiment 1.

The IP communication apparatus 1300 shown in FIG. 12 is intended to make IP (Internet Protocol) communication. For example, the IP communication apparatus 1300 is implemented as a set top box that receives content data transmitted via IP communication and outputs the content data to a television set.

The IP communication apparatus 1300 includes a packet processing unit 1310, an output unit 1320, and an attack packet, detecting apparatus 1350.

The attack packet detecting apparatus 1350 includes a network interface 101, and a main memory 1302.

The IP communication apparatus 1300 receives content data transmitted in units of packets via the network interface 101. The packet processing unit 1310 performs decoding and processing such as scramble release on the received content data to generate a signal including at least one of a video signal and an audio signal.

A signal generated by the packet processing unit 1310 is output to external apparatuses such as a television set connected to the IP communication apparatus 1300 via the output unit 1320.

Here, the packet processing unit 1310 reads the packets transferred from the network interface 101 to the main memory 1302 from the main memory 1302, and processes the packets.

Accordingly, even when the IP communication apparatus 1300 receives a DoS attack, the attack packets are discarded within the network interface 101, and the packets that make up the content data are transferred to the main memory 1302, and appropriately processed by the packet processing unit 1310.

Even when unknown attack packets are transmitted, the IP communication apparatus 1300 is capable of updating the attack packet table 109, and thereby discarding the attack packets before the attack packets are transferred to the main memory 1302. In short, the IP communication apparatus 1300 is capable of defending DoS attacks efficiently.

Each of the apparatuses shown in FIGS. 10 to 12 may include either a network interface 201 or a network interface 301, instead of the network interface 101. In whichever case, each of the apparatuses is capable of defending DoS attacks efficiently.

In the case where each of the apparatuses includes the network interface 301, the attack packet table 109 is updated by means that the CPU of each of the apparatuses executes an attack detection program.

### INDUSTRIAL APPLICABILITY

As described above, the present invention makes it possible to update an attack packet table using information obtained from received packets. Accordingly, whether or not received packets are attack packets is efficiently determined, which makes it possible to efficiently defense a DoS attack.

Therefore, the present invention is useful as attack packet detecting apparatuses and attack packet detecting methods for protecting network apparatuses from DoS attacks. The present invention is also useful as network apparatuses such as television sets, hard disk recorders, Blu-ray disc recorders, set top boxes, and the like.

### REFERENCE SIGNS LIST

101, 201, 301 Network interface
102, 1102, 1202, 1302 Main memory
103 Packet receiving unit
104 Comparing unit
104a Discarding unit
105 Packet buffer
106 Transfer unit
107 Attack detecting unit
108, 208 Update unit
109, 209 Attack packet table
110 Table storing unit
111 Statistical information
302 CPU
303 I/O unit
304 Interruption causing unit
1100 Video receiving apparatus
1110 Display control unit
1120 Tuner
1130 Decoder
1140 Display device
1150, 1250, 1350 Attack packet detecting apparatus
1200 Content recording apparatus
1210 Recording unit
1220 Recording medium
1230 Data processing unit
1240, 1320 Output unit
1300 IP communication apparatus
1310 Packet processing unit

1. An attack packet detecting apparatus including a receiving unit that receives packets, a packet buffer for accumulating the packets received by said receiving unit, and a transfer unit that transfers the packets accumulated in said packet buffer to a main memory, said attack packet detecting apparatus comprising:
an attack detecting unit configured to detect an attack in which a large number of packets is transmitted, based on an amount of packets accumulated in said packet buffer;
a storing unit configured to store attack packet information in which information for identifying attack packets is registered, the attack packets being the large number of packets used in the attack;
an update unit configured to update the attack packet information using information obtained from packets accumulated in said packet buffer, when the attack is detected by said attack detecting unit;
a discarding unit configured to discard the packets received by said receiving unit before the packets are transferred to said main memory, when the packets correspond to the information shown by the attack packet information updated by said update unit; and
a comparing unit configured to compare each of the packets received by said receiving unit and the attack packet information updated by said update unit, and when the packet do not correspond to the information shown by the attack packet information, transmit the packet to said packet buffer,
wherein said discarding unit is configured to discard the packets before the packets are transferred to said packet buffer, when a result of the comparison by said comparing unit shows that the packets correspond to the information shown by the attack packet information, and
said packet buffer is configured to accumulate the packets transferred by said comparing unit.

2. The attack packet detecting apparatus according to claim 1,
wherein said update unit is configured to obtain attribute information from each of the packets accumulated in said packet buffer, accumulate the number of packets or a total size of packets having the same attribute information, and when a result of the accumulation is equal to or greater than a predetermined threshold value, update the attack packet information by adding the attribute information to the attack packet information, and
said discarding unit is configured to discard the packets when the attribute information of the packets received by said receiving unit is included in the attack packet information updated by said update unit.

3. The attack packet detecting apparatus according to claim 2,wherein said update unit is configured to:
hold statistical information for recording (i) header information that is attribute information of the packets accumulated in said packet buffer, and (ii) an accumulated number of the packets or an accumulated size of the packets, in units of packets having the same header information;
read the header information of each of the packets accumulated in said packet buffer, when the attack is detected by said attack detecting unit, and either (a) add an entry of the header information to the statistical information when the read-out header information is not included in the statistical information, or (b) either add 1 to the accumulated number of the packets or adds the size of the packet to the accumulated size of the packets when the read-out header information is included in the statistical information, the accumulated number of the packets or the accumulated size of the packets corresponding to the header information; and
update the attack packet information indicated by the statistical information by adding, to the attack packet information, the header information corresponding to either the accumulated number of the packets or the accumulated size of the packets which is equal to or greater than the predetermined threshold value.

4. The attack packet detecting apparatus according to claim 1,
wherein said update unit is configured to obtain attribute information from the packets accumulated in said packet buffer, calculate an amount of increase in either an accumulated number of packets or an accumulated amount of packets having the same attribute information per unit time, and when a result of the calculation is equal to or greater than a predetermined threshold value, update the attack packet information by adding the attribute information to the attack packet information, and
said discarding unit is configured to discard the packets when the attribute information obtained from the packets received by said receiving unit is included in the attack packet information updated by said update unit.

5. The attack packet detecting apparatus according to claim 1,
wherein, in the attack packet information, an attack pattern that is the information for identifying the attack packets is registered in advance,
said update unit is configured to update the attack packet information by recording, in the attack packet information, information indicating that the attack pattern is valid when the information obtained from each of the packets accumulated in said packet buffer corresponds to the attack pattern, and
said discarding unit is configured to discard the packet having the valid attack pattern shown by the attack packet information.

6. (canceled)

7. The attack packet detecting apparatus according to claim 1,
wherein said attack detecting unit is configured to detect the attack by detecting that an accumulated amount of packets accumulated in said packet buffer or detecting that an amount of increase in the accumulated amount per unit time exceeds a predetermined threshold value.

8. The attack packet detecting apparatus according to claim 7,
wherein said transfer unit is configured to receive an update of a transfer speed that is the number of packets, which are accumulated in said packet buffer, transferred per unit time to said main memory, and transfer the packets accumulated in said packet buffer at the updated transfer speed.

9. The attack packet detecting apparatus according to claim 7,
wherein said attack detecting unit is configured to detect the attack by detecting a packet buffer overflow caused when the accumulated amount of packets accumulated in said packet buffer exceeds the predetermined threshold value.

10. A video receiving apparatus which receives video data, and displays, on a display device, a video represented by the received video data, said video receiving apparatus comprising:
said attack packet detecting apparatus according to claim 1; and
a display control unit configured to read packets transferred by said attack packet detecting apparatus to said main memory, and display video included in the read packets on said display device.

11. A content recording apparatus which receives content data including at least one of video data and audio data, and records the received content data, said content recording apparatus comprising:
said attack packet detecting apparatus according to claim 1; and
a recording unit configured to read, from said main memory, content data including packets transferred by said attack packet detecting apparatus to said main memory, and record the content data on a recording medium.

12. An IP (Internet Protocol) communication apparatus which performs IP communication, comprising:
said attack packet detecting apparatus according to claim 1;
a packet processing unit configured to read, from said main memory, packets transferred by said attack packet detecting apparatus to said main memory, and process the packets to generate a signal including at least one of a video signal and an audio signal; and
an output unit configured to output the signal generated by said packet processing unit to an external device.

13. An attack packet detecting method performed by an attack packet detecting apparatus including a receiving unit that receives packets, a packet buffer for accumulating the packets received by the receiving unit, and a transfer unit that transfers the packets accumulated in the packet buffer to a main memory, said attack packet detecting method comprising:
detecting an attack in which a large number of packets is transmitted, based on an accumulated amount of packets in the packet buffer;
updating attack packet information in which information for identifying attack packets is registered, using information obtained from the packets accumulated in the packet buffer, when the attack is detected in said detecting, the attack packets being the large number of packets used in the attack;
discarding the packets before the packets received by the receiving unit are transferred to the main memory, when the packets correspond to information shown by the attack packet information updated in said updating;
comparing each of the packets received by the receiving unit and the attack packet information updated in said updating; and
transmitting the packet to the packet buffer so that the packet is accumulated in the packet buffer, when a result of the comparison in said comparing shows that the packet do not correspond to the information shown by the attack packet information,
wherein, in said discarding, the packets are discarded before the packets are transferred to the packet buffer, when a result of the comparison in said comparing shows that the packets correspond to the information shown by the attack packet information.

14. A program recorded on a non-transitory computer-readable recording medium for use in a computer, said program causing the computer to execute at least part of processing performed by an attack packet detecting apparatus,
wherein the attack packet detecting apparatus includes:
a receiving unit which receives packets;
a packet buffer which accumulates packets received by the packet buffer;
a transfer unit which transfers the packets accumulated in the packet buffer to a main memory;
an attack detecting unit which detects an attack in which a large number of packets is transmitted, based on an accumulated amount of packets in the packet buffer;
a storing unit which stores attack packet information in which information for identifying the attack packets is registered, the attack packets being the large number of packets used in the attack; and
a discarding unit which discards the packets received by the receiving unit before the packets are transferred to the main memory, when the packets correspond to information shown by the attack packet information recorded in the recording unit,
said program causing the computer to execute:
updating the attack packet information using information obtained by the packets accumulated in the packet buffer, when the attack is detected by the attack detecting unit;
comparing each of the packets received by the receiving unit and the attack packet information updated in the updating;
transmitting the packet to the packet buffer so that the packet is accumulated in the packet buffer, when a result of the comparison in the comparing shows that the packet do not correspond to the information shown by the attack packet information; and
discarding the packets before the packets are transferred to the packet buffer, when a result of the comparison in the comparing shows that the packets correspond to the information shown by the attack packet information.
